(19) United States
(12) Patent Application Publication
(10) Pub. No.: US 2018/0169606 A1
(43) Pub. Date: Jun. 21, 2018

(54) APPARATUS FOR PRODUCING INORGANIC POWDER AND APPARATUS FOR PRODUCING AND CLASSIFYING INORGANIC POWDER

(71) Applicant: Industrial Technology Research Institute, Hsinchu (TW)

(72) Inventors: Chun-An Lu, New Taipei City (TW); Yuan-Ling Tsai, Changhua County (TW); Chiung-Hsiung Chen, Hsinchu County (TW); Yi-Chen Wu, Nantou County (TW); Shih-Chin Lin, New Taipei City (TW)

(73) Assignee: Industrial Technology Research Institute, Hsinchu (TW)

(21) Appl. No.: 15/832,736

(22) Filed: Dec. 5, 2017

(30) Foreign Application Priority Data
Dec. 21, 2016 (TW) 105219426

(51) Int. Cl. B01J 19/08; B01J 19/12

(52) U.S. Cl. CPC B01J 19/088; B01J 19/129; B01J 2219/0809; B01J 2219/0875; B01J 2219/0898

(57) ABSTRACT

An apparatus for producing an inorganic powder and an apparatus for producing and classifying an inorganic powder are provided, wherein the apparatus for producing an inorganic powder includes an insulating tube, at least one pair of annular RF electrodes, and a gas supply apparatus. The pair of annular RF electrodes surrounds the outer circumference of the insulating tube to generate a first electric field region outside the insulating tube and generate a second electric field region having a plasma torch in the insulating tube after being turned on. The gas supply apparatus supplies a reaction mist and an inert gas into the insulating tube to thermally degrade and oxidize the reaction mist into an inorganic powder via the plasma torch.

### CROSS-REFERENCE TO RELATED APPLICATION

This application claims the priority benefit of Taiwan application serial no. 105219426, filed on Dec. 21, 2016. The entirety of the above-mentioned patent application is hereby incorporated by reference herein and made a part of this specification.

### TECHNICAL FIELD

The disclosure relates to an apparatus for producing an inorganic powder and an apparatus for producing and classifying an inorganic powder.

### BACKGROUND

High-purity inorganic powders are extensively applied in various industries, including the ceramic passive device industry, structural ceramics industry, display industry, and the semiconductor industry. In addition to considering the size and fineness of the inorganic powder, the crystallinity, morphology, and purity of the inorganic powder itself all have strictly defined specifications in application because these specifications represent, for instance, the mechanics, electrical characteristics, dielectricity, magnetism, thermal characteristics, and optical characteristics of the powder. The size, morphology, particle size uniformity, surface area, crystallinity, etc. of the inorganic powder are significantly related to the inorganic powder synthesis method.

In the case of preparing the inorganic powder using a metal organic salt, the metal organic salt is first dissolved in a specific solvent, and then an amine is often added to perform a heating wet reduction to obtain the inorganic powder. However, limited by yield and waste liquid pollution coupled with the degradation temperature of some metal organic salts being too high, the problem such as dangerous caused by a thermal reduction performed at a high temperature in a reactor may be occurred. Therefore, in some techniques, powder preparation is performed using a spray thermal degradation method. Considering heating interval and temperature, such a reactor mostly has a certain length, and a reaction time that is too long has a significant effect on the control of particle size and the uniformity of, for instance, crystallinity. Moreover, the treatment of the resulting exhaust gas is also a big issue, which indirectly causes the collection of the resulting inorganic powder to generally require a backend classification equipment treatment, thus significantly limiting yield.

Moreover, the reaction precursor formed by dissolving a metal organic salt in a specific solvent has issues such as the inability to be applied in a high-speed spray treatment of a high-pressure spray, corrosion of nozzle material, and contamination in the reaction chamber resulting in reduced purity of the inorganic powder.

Moreover, inorganic powder production techniques need to consider conditions such as mass production, continuity, and environmental friendliness, and production costs need to be effectively lowered, the continuity of the overall production needs to be effectively designed and achieved, the inorganic powder needs to be readily accessible, and at the same time, classification and process environmental pollution should be minimized. Lastly, the size, uniformity, morphology, and surface area of the inorganic powder and the crystallinity, dispersibility, and functionality of the material itself all need to be considered as well.

### SUMMARY

The apparatus for producing an inorganic powder of the disclosure includes an insulating tube, at least one pair of annular RF electrodes, and a gas supply apparatus. The pair of annular RF electrodes surrounds the outer circumference of the insulating tube to generate a first electric field region outside the insulating tube and generate a second electric field region having a plasma torch in the insulating tube after being turned on. The gas supply apparatus supplies a reaction mist and an inert gas into the insulating tube to degrade and oxidize the reaction mist into the inorganic powder via the plasma torch.

The apparatus for producing and classifying an inorganic powder of the disclosure includes an atomization equipment, a plasma equipment, and a classification equipment connected to the plasma equipment. The atomization equipment is used to atomize a reaction liquid into a reaction mist. The plasma equipment includes an insulating tube connected to the atomization equipment, a high-pressure gas supply apparatus, and at least one pair of annular RF electrodes. The high-pressure gas supply apparatus is used to supply an inert gas to the atomization equipment such that the reaction mist and the inert gas enter the insulating tube together. The annular RF electrodes surround the outer circumference of the insulating tube to generate a first electric field region outside the insulating tube and generate a second electric field region having a plasma torch in the insulating tube after being turned on such that the reaction mist is degraded and oxidized into an inorganic powder by the plasma torch. The classification equipment includes a plurality of dry vortex cones having different radii to classify the inorganic powder.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a 3D schematic of an apparatus for producing an inorganic powder according to an embodiment of the disclosure.

FIG. 2 is a cross section of the apparatus for producing an inorganic powder of FIG. 1.

FIG. 3 is a schematic of an apparatus for producing and classifying an inorganic powder according to another embodiment of the disclosure.

FIG. 4 is a detailed schematic of a dry vortex cone in FIG. 3.

### DETAILED DESCRIPTION OF DISCLOSED EMBODIMENTS

Hereinafter, the concepts of the disclosure are more comprehensively described with reference to figures with embodiments. However, the disclosure can also be implemented in many different forms and should not be construed to be limited to the embodiments below. In the figures, for clarity, the relative thickness and location of each layer, region, structure, and/or apparatus may be reduced or enlarged. Moreover, similar or the same reference numerals are used in each figure to represent similar or the same devices or features. It should be understood that, when a device is described as “connected” to another device, the device can be directly connected to the other device or an intermediate device can be present; on the other hand, when the device is described as “directly connected” to another device, an intermediate device is not present. Other spatial terms describing the relationship between the devices or film layers should be understood in the same manner.

An apparatus for producing an inorganic powder provided by the disclosure can produce a submicron inorganic powder that is easily classified.

The disclosure further provides an apparatus for producing and classifying an inorganic powder that can continuously produce a micron-grade or nano-grade inorganic powder on different scales.

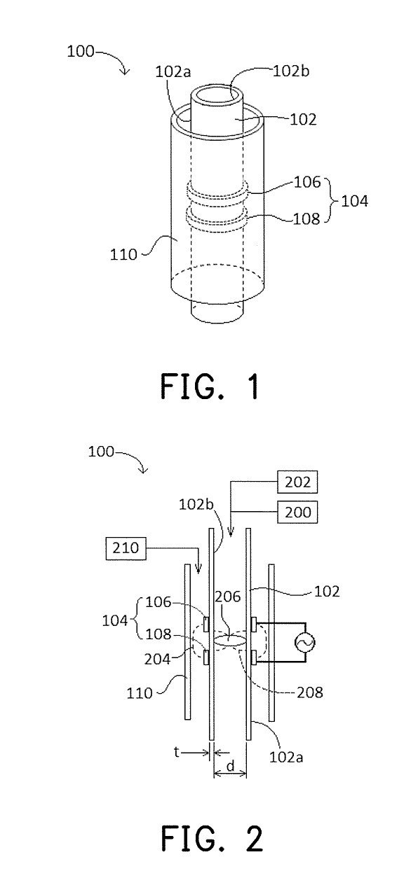

FIG. 1 is a 3D schematic of an apparatus for producing an inorganic powder according to an embodiment of the disclosure. FIG. 2 is a cross section of the apparatus for producing an inorganic powder of FIG. 1.

Referring to FIG. 1, an apparatus 100 for producing an inorganic powder of the present embodiment includes an insulating tube 102 having an outer circumference 102a and an inside 102b, the insulating tube 102 is, for instance, a ceramic tube having a resistivity of 10⁹ Ω·cm or more, and the material of the insulating tube 102 can include, but is not limited to, for instance, aluminum oxide, zirconium oxide, aluminum nitride, silicon nitride, silicon carbide, or a combination thereof. The apparatus 100 for producing an inorganic powder further includes at least one pair of annular RF electrodes 104 surrounding the outer circumference 102a of the insulating tube 102, wherein the annular RF electrodes 104 are formed by a positive electrode 106 and a negative electrode 108, and the material of the annular RF electrodes 104 can be, but is not limited to, for instance, copper, silver, gold, aluminum, nickel, or a combination thereof. In another embodiment, the number of pairs of the annular RF electrodes 104 can also be increased to increase the reaction region in the insulating tube 102 to further increase reaction time. In an embodiment, the shape of the annular RF electrodes 104 matches the outer circumference 102a of the insulating tube 102. For instance, when the insulating tube 104 is a round tube, the shape of the annular RF electrodes 104 can be a circle, a C shape, or an arc, but is not limited thereto. In an embodiment, the apparatus 100 for producing an inorganic powder can also have an outer tube 110 surrounding the insulating tube 102 and the annular RF electrodes 104. In an embodiment, the material of the outer tube 110 is the same as that of the insulating tube 102 and is therefore not repeated herein.

Next, referring to FIG. 2, in addition to the structure in FIG. 1, the apparatus 100 for producing an inorganic powder of the present embodiment further has a gas supply apparatus. Specifically, the gas supply apparatus is, for instance, a reaction mist supply apparatus 200 and a high-pressure gas supply apparatus 202 to supply a reaction mist and an inert gas into the insulating tube 102, wherein the reaction mist is, for instance, a misty object of a metal organic salt precursor; and the inert gas is, for instance, high-concentration argon, such as argon having a purity of 99.9% or more or a mixed gas containing argon and air, wherein the mixed gas includes 5 mol % to 15 mol % of oxygen, for example. The metal organic salt precursor refers to a combination of a metal organic salt and a solvent, such as a metal organic salt having a chemical formula of [CₙH₂ₙ₊₁COO]_{A}Re, wherein A=1 to 5; n=5 to 19; and Re is Y, La, Dy, Nd, Ce, Pr, Gd, Ag, Cu, Zn, Sr, or a combination thereof. The solvent is, for instance, toluene, xylene, paramenthene acetate, butyl acetate, or a combination thereof. In another embodiment, the gas supply apparatus is, for instance, the reaction mist supply apparatus 200 connected to the insulating tube 102 and the high-pressure gas supply apparatus 202 (such as a high-pressure gas cylinder) connected to the reaction mist supply apparatus 200 for supplying a high-pressure inert gas into the reaction mist supply apparatus 200 and driving the reaction mist by high-pressure gas into the insulating tube 102.

During the reaction, the annular RF electrodes 104 generate a first electric field region 204 outside the insulating tube 102 and generate a second electric field region 208 having a plasma torch 206 in the insulating tube 102 after being turned on, wherein the electric field strength of the first electric field region 204 is greater than the electric field strength of the second electric field region 208. Therefore, when the reaction mist supplied by the reaction mist supply apparatus 200 passes through the plasma torch 206, the reaction mist is degraded and oxidized into an inorganic powder, wherein the particle size of the degraded inorganic powder is 50 microns to 500 microns. In an embodiment, the radio frequency is between 100 kHz and 1000 kHz; the high-voltage range is between 0.5 kV and 5 kV; and the output wattage is between 0.5 kW and 5 kW. Based on the above conditions of the annular RF electrodes 104, a diameter d of the insulating tube 102 can be set to 8 cm or less, and a tube wall thickness t can be 3 mm or less. Moreover, a nitrogen supply apparatus 210 can be added to supply nitrogen into the outer tube 110 such that nitrogen is filled between the outer tube 110 and the insulating tube 102 to prevent the first electric field region 204 from generating an electric arc or even an explosion.

In the present embodiment, a high electric field is applied using the annular RF electrodes 104 disposed in the outer circumference 102a of the insulating tube 102, and a high-concentration inert gas (such as argon having a purity of 99.99%) is supplied by the inside 102b of the insulating tube 102 to form a plasma. Since the tube wall of the insulating tube 102 adopts a high insulation material, the electric field strength of the second electric field region 202 inside the insulating tube 102 can be limited, such that internal plasma concentration, temperature, and strength are weaker, and the reaction mist passing through can be degraded and oxidized and is not vaporized by the excessive strength of the plasma torch 206. As a result, the issues of requiring additional cooling regions and difficulty in collecting an inorganic powder that is too small are prevented.

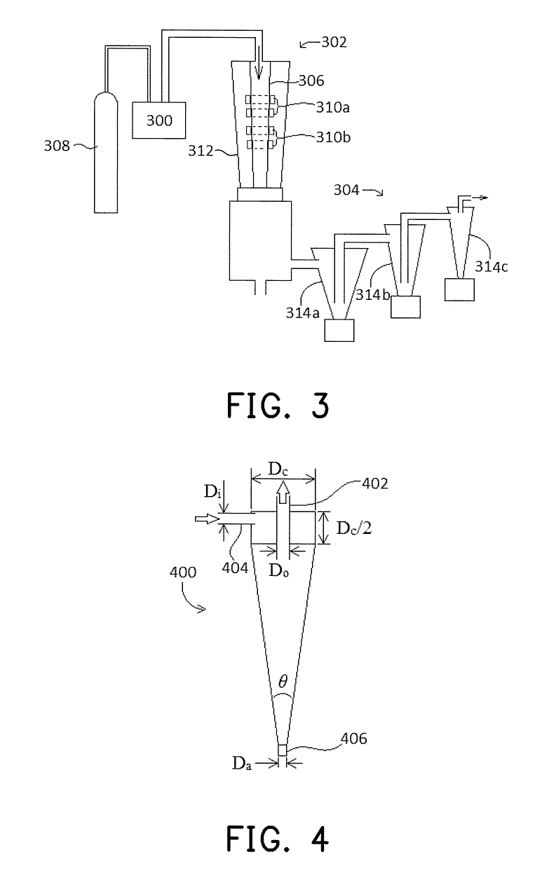

FIG. 3 is a schematic of an apparatus for producing and classifying an inorganic powder according to another embodiment of the disclosure.

Referring to FIG. 3, the apparatus for producing and classifying an inorganic powder of the present embodiment includes an atomization equipment 300, a plasma equipment 302, and a classification equipment 304. The atomization equipment 300 is used to atomize a reaction liquid into a reaction mist, wherein the atomization equipment 300 is, for instance, a piezoelectric oscillator or an ultrasonic oscillator, and the reaction liquid is, for instance, the metal organic salt precursor in the above embodiment which is therefore not repeated herein. The insulating tube 306 in the plasma equipment 302 is connected to the atomization equipment 300, and the plasma equipment 302 has a high-pressure gas supply apparatus 308 (such as a high-pressure gas cylinder) to supply an inert gas to the atomization equipment 300 such that the reaction mist and the inert gas enter the insulating tube 306 together. The inert gas is, for instance, argon having a purity of 99.9% or more or a mixed gas of argon and air, wherein the mixed gas of argon and air includes 5 mol % to 15 mol % of oxygen. The insulating tube 306 in the present embodiment is, for instance, a ceramic tube having a resistivity of 10⁹ Ω·cm or more, and the material thereof is, for instance, aluminum oxide, zirconium oxide, aluminum nitride, silicon nitride, silicon carbide, or a combination thereof. The plasma equipment 302 further includes two pairs of annular RF electrodes 310a and 310b surrounding the outer circumference of the insulated tube 306 to generate a first electric field region outside the insulating tube 306 and generate a second electric field region having a plasma torch in the insulating tube 306 after being turned on. The details are as shown in FIG. 2, wherein the electric field strength of the first electric field region is greater than the electric field strength of the second electric field region. When the atomized reaction liquid is driven by a high-pressure gas to enter the insulating tube 306, the atomized reaction liquid passes through the plasma torch and is degraded and oxidized into an inorganic powder. Moreover, similar to the embodiment above, the outer circumference of the insulating tube 306 of the present embodiment can also include an outer tube 312 surrounding two pairs of annular RF electrodes 310a and 310b and supply nitrogen into the outer tube 312 via a nitrogen supply apparatus (not shown). Next, the reacted inorganic powder can be imported into the classification equipment 304 connected to the plasma equipment 302 using a high-pressure airflow method. The classification equipment 304 includes a plurality of dry vortex cones 314a, 314b, and 314c having different radii to classify the inorganic powder.

FIG. 4 is a detailed schematic of a dry vortex cone in FIG. 3. A dry vortex cone 400 represents each of the dry vortex cones in the classification equipment 304, wherein a cone angle θ is about less than 20 degrees. The dry vortex cone 400 has an exit 402, a gas inlet 404, and a powder outlet 406. In an embodiment, a diameter Do of the exit 402 is a maximum diameter Dc divided by N (Do=Dc/N), wherein N=3.5 to 5.5; a diameter Di of the gas inlet 404 is the maximum diameter Dc divided by M (Di=Dc/M), wherein M=5.5 to 8.5; a diameter Da of the powder outlet 406 is the maximum diameter Dc divided by L (Da=Dc/L), wherein L=6.5 to 10. The gas inlet 404 is generally connected to an upper horizontal region of the dry vortex cone 400, and has a height of about Dc/2.

Based on the above, in the disclosure, by disposing annular RF electrodes in the outer circumference of the insulating tube to reduce the low-concentration plasma reaction region formed in the tube by the electric field strength, a discharge effect can be prevented from causing material vaporization so as to perform a rapid thermal degradation reaction to form an inorganic powder. Moreover, in the disclosure, a continuous production apparatus is formed by integrating an atomization equipment, an RF plasma torch, and a dry vortex classification equipment, and the continuous production apparatus can effectively improve the reaction time of the original powder synthesis, lower pollution, and achieve the effects of continuous reaction and powder auto classification.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. An apparatus for producing an inorganic powder, comprising:
an insulating tube;
at least one pair of annular RF electrodes surrounding an outer circumference of the insulating tube to generate a first electric field region outside the insulating tube and generate a second electric field region having a plasma torch in the insulating tube after being turned on; and
a gas supply apparatus supplying a reaction mist and an inert gas into the insulating tube to degrade and oxidize the reaction mist into the inorganic powder via the plasma torch.

2. The apparatus for producing the inorganic powder of claim 1, wherein the insulating tube comprises a ceramic tube having a resistivity of 10⁹ Ω·cm or more.

3. The apparatus for producing the inorganic powder of claim 1, wherein a material of the insulating tube comprises aluminum oxide, zirconium oxide, aluminum nitride, silicon nitride, silicon carbide, or a combination thereof.

4. The apparatus for producing the inorganic powder of claim 1, wherein an electric field strength of the first electric field is greater than an electric field strength of the second electric field.

5. The apparatus for producing the inorganic powder of claim 1, further comprising:
an outer tube surrounding the insulating tube and the pair of annular RF electrodes; and
a nitrogen supply apparatus supplying nitrogen into the outer tube.

6. The apparatus for producing the inorganic powder of claim 1, wherein the gas supply apparatus comprises:
a reaction mist supply apparatus connected to the insulating tube to supply the reaction mist; and
a high-pressure gas supply apparatus connected to the reaction mist supply apparatus to supply the inert gas to the reaction mist supply apparatus.

7. The apparatus for producing the inorganic powder of claim 1, wherein the reaction mist comprises a metal organic salt precursor.

8. The apparatus for producing the inorganic powder of claim 1, wherein the inert gas comprises argon having a purity of 99.9% or more or a mixed gas of argon and air.

9. An apparatus for producing and classifying an inorganic powder, comprising:
an atomization equipment atomizing a reaction liquid into a reaction mist;
a plasma equipment, comprising:
an insulating tube connected to the atomization equipment;
a high-pressure gas supply apparatus supplying an inert gas to the atomization equipment such that the reaction mist and the inert gas enter the insulating tube together; and
at least one pair of annular RF electrodes surrounding an outer circumference of the insulating tube to generate a first electric field region outside the insulating tube and generate a second electric field region having a plasma torch in the insulating tube after being turned on such that the reaction mist is degraded and oxidized into an inorganic powder by the plasma torch; and
a classification equipment connected to the plasma equipment, wherein the classification equipment comprises a plurality of dry vortex cones having different radii to classify the inorganic powder.

10. The apparatus for producing and classifying the inorganic powder of claim 9, wherein the insulating tube comprises a ceramic tube having a resistivity of 10⁹ Ω·cm or more.

11. The apparatus for producing and classifying the inorganic powder of claim 9, wherein a material of the insulating tube comprises aluminum oxide, zirconium oxide, aluminum nitride, silicon nitride, silicon carbide, or a combination thereof.

12. The apparatus for producing and classifying the inorganic powder of claim 9, wherein an electric field strength of the first electric field region is greater than an electric field strength of the second electric field region.

13. The apparatus for producing and classifying the inorganic powder of claim 9, wherein the plasma equipment further comprises:
an outer tube surrounding the insulating tube and the pair of annular RF electrodes; and
a nitrogen supply apparatus supplying a nitrogen into the outer tube.

14. The apparatus for producing and classifying the inorganic powder of claim 9, wherein the reaction liquid comprises a metal organic salt precursor.

15. The apparatus for producing and classifying the inorganic powder of claim 9, wherein a cone angle of the dry vortex cones is less than 20 degrees.

16. The apparatus for producing and classifying the inorganic powder of claim 9, wherein each of the dry vortex cones has an exit, a gas inlet, and a powder outlet, a diameter of the exit is a maximum diameter divided by N, a diameter of the gas inlet is the maximum diameter divided by M, and a diameter of the powder outlet is the maximum diameter divided by L, wherein N=3.5 to 5.5, M=5.5 to 8.5, and L=6.5 to 10.

17. The apparatus for producing and classifying the inorganic powder of claim 9, wherein the atomization equipment comprises a piezoelectric oscillator or an ultrasonic oscillator.

18. The apparatus for producing and classifying the inorganic powder of claim 9, wherein the high-pressure gas supply apparatus comprises a high-pressure gas cylinder.

19. The apparatus for producing and classifying the inorganic powder of claim 9, wherein the inert gas comprises argon having a purity of 99.9% or more or a mixed gas comprising argon and air.

20. The apparatus for producing and classifying the inorganic powder of claim 19, wherein the mixed gas comprises 5 mol % to 15 mol % of oxygen.
